(19) United States
(12) Patent Application Publication
(10) Pub. No.: US 2024/0184637 A1
(43) Pub. Date: Jun. 6, 2024

(54) MACHINE LEARNING MODEL DISTRIBUTION ARCHITECTURE

(71) Applicant: Tektronix, Inc., Beaverton, OR (US)

(72) Inventors: John J. Pickerd, Hillsboro, OR (US); Sam J. Strickling, Cypress, TX (US); Mark Anderson Smith, Portland, OR (US); Sunil Mahawar, Portland, OR (US)

(73) Assignee: Tektronix, Inc., Beaverton, OR (US)

(21) Appl. No.: 18/523,556

(22) Filed: Nov. 29, 2023

Related U.S. Application Data
(60) Provisional application No. 63/429,538, filed on Dec. 1, 2022.

(51) Int. Cl. G06F 9/50; G06F 11/36

(52) U.S. Cl. CPC G06F 9/5077; G06F 11/362

(57) ABSTRACT

A machine learning management system includes a repository having one or more partitions, the one or more partitions being separate from others of the partitions, a communications interface, and one or more processors configured to execute code to: receive a selected model and associated training data for the selected model through the communications interface from a customer; store the selected model and the associated training data in a partition dedicated to the customer; and manage the one or more partitions to ensure that the customer can only access the customer's partition. A method includes receiving a selected model and associated training data for the selected model from a customer, storing the selected model and the associated training data in a partition dedicated to the customer in a repository, and managing the one or more partitions to ensure that the customer can only access the partition dedicated to the customer.

### CROSS-REFERENCE TO RELATED APPLICATIONS

This disclosure claims benefit of U.S. Provisional Application No. 63/429,538, titled “MACHINE LEARNING MODEL DISTRIBUTION ARCHITECTURE,” filed on Dec. 1, 2022, the disclosure of which is incorporated herein by reference in its entirety.

### TECHNICAL FIELD

This disclosure relates to test and measurement systems, and more particularly to test and measurement systems that employ a trainable machine learning model component.

### BACKGROUND

U.S. patent application Ser. No. 18/482,765, filed Oct. 6, 2023, that claims priority to U.S. Prov. Pat. App. No. 63/415,588, filed Oct. 12, 2022, titled “COMPREHENSIVE MACHINE LEARNING MODEL DEFINITION,” hereinafter “the '765 application,” the contents of which are hereby incorporated by reference into this disclosure, describes a machine learning model definition that allows for efficient and convenient distribution of the machine learning models.

The management, distribution, and other related aspects of the machine learning models can raise the complexity of the system. This may make the system less useful to customers than desired.

### BRIEF DESCRIPTION OF THE DRAWINGS

FIG. 1a shows a block diagram of an embodiment of a manufacturing system.

FIG. 2 shows a block diagram of an embodiment of a system to distribute and maintain trained and untrained models of deep learning neural networks and related information.

FIG. 3 shows a detailed view of a customer repository and manufacturing subsystem useable in the system of FIG. 2.

FIG. 4 shows a detailed view of an embodiment of a repository usable in the system of FIG. 2.

### DETAILED DESCRIPTION

The embodiments provide a system architecture and method for the training and distribution of trained and untrained machine learning models. The embodiments involve local customer repositories at each customer's location, a centralized repository having partitions for each customer, and provides a way for distribution of customer local trained models to manufacturing stations and copying and storing in the centralized repository. This all occurs under control of a system that manages and controls access to each customer's data and models, trained and untrained, to keep it all secure and only available to those with access.

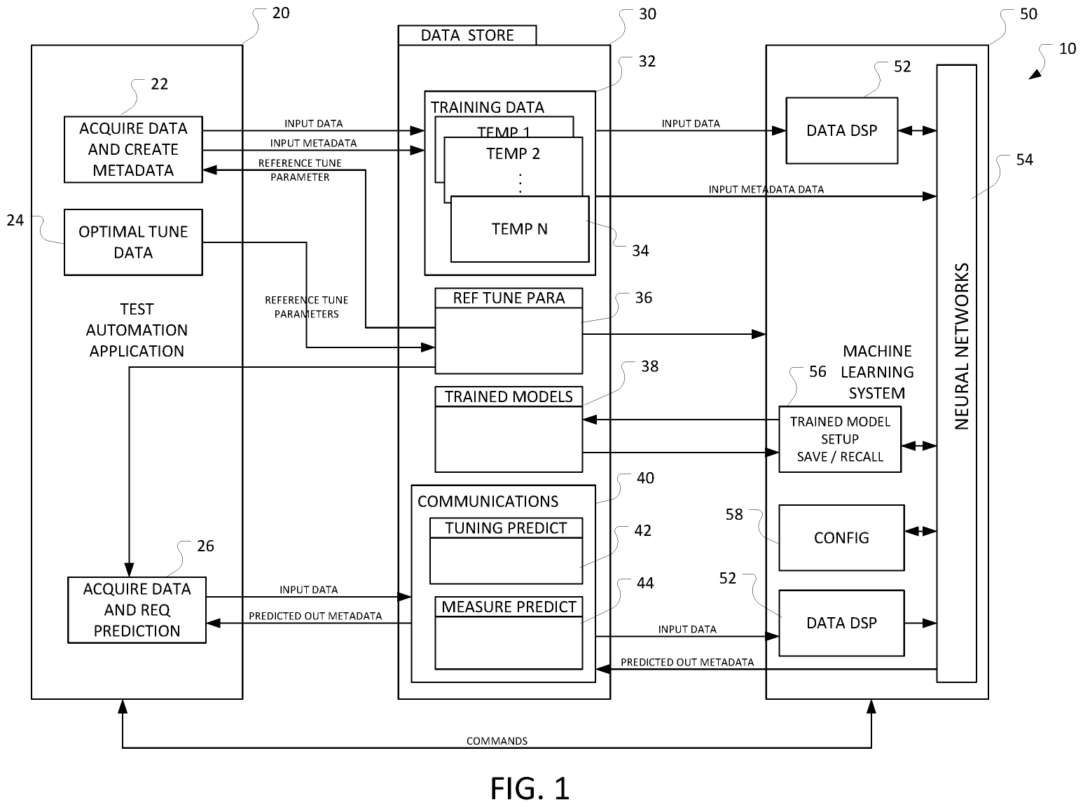

FIG. 1 shows an embodiment of a manufacturing system 10 that has deployed OptaML. In FIG. 1, the customer automation software or system 20 is written and maintained by the customer. It acts as the master manufacturing controller software. It controls ovens, optical switches, oscilloscopes, ML Tools SW application, and potentially other components. Its responsibilities include controlling the DUT and measurement instruments to collect waveforms, S-parameters, or other data from DUTs to use for training the ML Tools Application neural networks. They also include the tasks to define the metadata which the neural networks will predict and/or associate with the collected DUT data. Another responsibility involves collecting all training data, formatting it with predefined naming conventions, and placing it in pre-defined data store locations. In one embodiment, the customer automation system also will place training metadata into data files of a more universal format, such as *.csv files. During run time it collects data from the DUT and controls the process of providing it to the ML Tools application to receive a tuning or measurement prediction.

The customer automation system application 20 may have many other components than those shown in FIG. 1. The Acquire Data block 22 collects the necessary data from DUTs for training the deep learning networks in the ML Tools Application SW. It then stores the data and metadata in the data store. In one embodiment, the training data portion 32 of store 30 may store the data in a structure with a folder or other designated area such as 34 for each temperature at which the DUTs are tested.

The customer system will be configured to sample many DUT devices and determine their optimal tuning using the customer's standard tuning process for the DUTs at 24. Once that occurs, it creates the reference tuning parameter sets that are needed for training and for runtime predictions. This block then stores the reference parameters sets in the data store at 36.

During runtime, the customer's system loads reference parameters into their DUT and collects waveforms or S-parameters at 26. It then provides these as input to the ML Tools Application through the data store communication portion 40 and then receives back predicted metadata also through the communication portion of the data store. This may be a set of optimal tuning parameters stored at 42, or it may be a measurement such as TDECQ or other at 44.

As mentioned above the data store 30 acts as the communications interface between the Customer Automation System 20 and the ML Tools application 50. It contains all the data 32 and 36 used to train the model, the trained neural networks 38, all the ML Tools System class variables setup data for both training and predictions, and the communication folders 40, 42 and 44, for making runtime predictions.

The training data folder 32 may receive and contain input data in the form of waveform data, S-parameter data, or other data that will be used for training and input for predictions. It will contain input metadata associated with the input waveform or S-parameter data, possibly in input file such as in the *.csv files mentioned above. The ML Tools application may create animation files during the training procedure. They contain one frame of image tensor and the metadata for each of the thousands of input waveforms. The ML Tool application stores these in the data store.

The reference tuning parameters folder 36 contains three or more sets of reference tuning parameters needed for collecting training data or for collecting data in runtime prediction processes for tuning processes. The customer automation system 20 loads the reference parameter sets into the DUTs and collects three waveforms or three sets of S-parameters. The system uses these as input to the deep learning networks 54 for training or for runtime prediction.

Once a model has been trained, the ML Tools application then creates a set up file and saves it to store, or substore, 38 of the data store 30. This file contains the trained neural networks. It also contains the setup class variable values for the entire ML Tools application for both training and for run time prediction. The user may have created more than one trained setup file model for their given DUT model. Typically, the ML Tools application will only train one model and store it in this portion. For example, perhaps a new model was trained because the DUT characteristics changed at some point in time. The ML Tools application may store the old model and the new model. Other reasons may exist why multiple trained setups could be saved.

During runtime for predictions using the trained networks, the customer automation system 20 places data from the DUT in one of the communications stores 40. The data results from placing the reference tuning parameters into a DUT and a PI (programmatic interface) command or front panel button press causes ML Tools Application to make a prediction using the data as input. The ML Tools application then places the prediction back into communications store 40. A PI OK handshake may go back to the Customer Automation system, which then reads the predicted results. The communications store 40 may contain a communication folder for making DUT tuning predictions, such as 42, and a communications folder for making measurements such as 44. The communications store 40 may contain other communication folders depending on the specific system selected in the ML Tools application. Similarly, there may be other stores within the data store. Different system applications that may be implemented for selection by the user from the ML Tools System menu, may require modifications to this model filter structure.

The model is structured in a way which simplifies the procedure for the system architecture to step through processing it to create the training data arrays. This keeps all input data and all metadata consistent. As mentioned above, the data store also supports training at different values of operating parameters, such as temperature. Again, this simplifies the data processing and associations internally. This makes it easier for the customer to manage and visualize the data, giving them better insight into the nature of their DUT. One such visualization may represent temperature as a bar graph in the tensor images built for prediction and training.

An important element of the store is the trained model either saved or recalled by using a File>Recall trained setup or File Save trained setup pulldown menu or PI command. This file contains all system class variables needed for setup of the entire system application for both training and run time predictions. It also includes the trained neural networks in the system.

The various elements of the data store are represented by a structure of stores, or substores, such as folders and files. The organization of the data may include individual files as shown, or combinations of files that pull the data into different kinds of structures other than the example shown. The data store has several aspects including a single structured store containing am data portable to multiple computers that run the OptaML™ ML Tools software to make tuning predictions, a set of folders to support waveform data and metadata for training the deep learning networks, and substores and files to support the specific system training and runtime prediction. These may include reference tuning parameters and an array of OptaML™ tuning parameters used to determine reference tuning parameters. The store also includes a store containing the trained model file containing trained deep learning neural networks, all system class variables states needed for training and prediction. The data store also includes communications store(s) for inputting waveforms data for making predictions from the trained networks, and for containing the predicted results. In different embodiments, the data store and substores may be organized into different hierarchies.

The ML Tools application 50 performs the required digital signal processing (DSP) 52 to transform input data to tensor structures to be used as input to train the deep learning networks or to obtain predictions from them. The ML Tools application has a Save/Recall trained model setup block 56 that saves the entire system setup including trained neural networks into one or more data stores. System configuration 58 represents all the applications class variables and neural network states needed to perform both training and runtime predictions. In one embodiment the data store 38 may comprise a single file. Alternatively, this could exist as more than one file. This block also allows for recalling and loading a saved model setup file into the system.

The DSP block mentioned above 52 contains all system DSP transforms that are needed to apply to the input data waveforms or S-parameters, and then incorporate them into a tensor format suitable for input to the deep learning network design being used. Two of them are shown in the block diagrams, but it is only one DSP block 52, the application just uses it in two different areas, in both prediction and training. This ensures that the entire system set up for both training and prediction remains consistent. Data must be processed identically for both training and prediction.

The embodiments here build on the system in the '588 application referenced above to define an architecture for the training, distribution, deployment, and maintenance of trained and untrained machine learning model structures. In this disclosure, an example embodiment of such an architecture may be referred to as being implemented in an OptaML™ application.

The below discussion mentions computing devices located locally to customers, and remotely from customers but under the control of Tektronix. These computing devices each have one or more processors, but the reference to “one or more processors” as used here may also mean all the processors that operate across the software across system, regardless of location.

A particular example of an OptaML™ application may be referred to in this disclosure as OptaML™ Pro. The OptaML™ Pro application is designed for determining optimal tuning parameters for optical transmitters/transceivers, such as in a manufacturing environment, for example. The OptaML Pro™ application receives waveforms from a customer's transmitter and uses machine learning to predict the optimal set of tuning parameters for that transmitter.

One should note that the term “OptaML” refers to any version of a software application provided by Tektronix, Inc. to customers for testing of devices under test. The name OptaML may be altered or changed completely, but by any name, the application referred to herein uses training data from the testing and tuning of devices under test (DUT) to train models to allow machine learning to perform the testing and tuning instead.

Each customer may have multiple transmitter models to train. Each customer should train for their own models and no other customer's models. Embodiments of the disclosure generally enable this capability.

As used here, the term “untrained model” means a folder or other storage structure that contains the training waveforms and metadata, but the deep learning neural networks have not yet been trained. The untrained model does not contain a saved model file containing trained neural networks and system class variable states. As used here, the term “trained model” means a folder or other storage structure that contains the trained neural network and all the system class variable states needed to run the model.

An application engineer, who the below discussion may refer to as an OptaML engineer, may take an untrained model and train it to make it ready for deployment by the customer. The trained model now contains a model file containing the trained neural networks and all the system class variable states needed to run the model. In some embodiments of the disclosure, access to training functionality may be restricted to application engineers. However, in other embodiments, the system may have the ability to give customers access to training functionality as well.

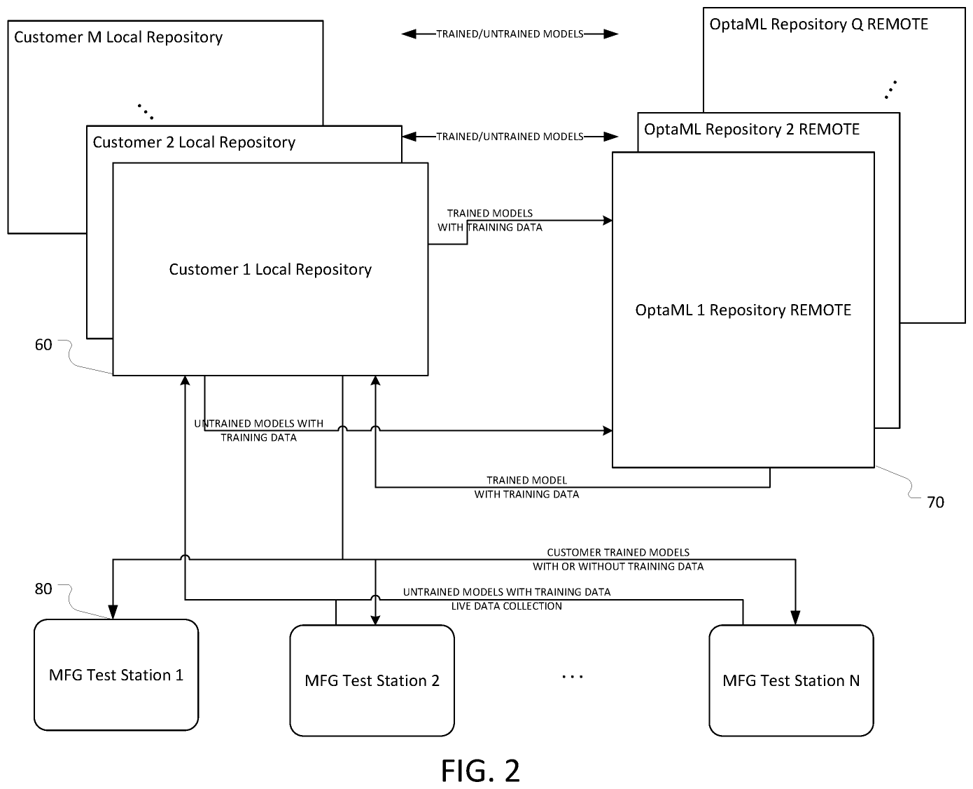

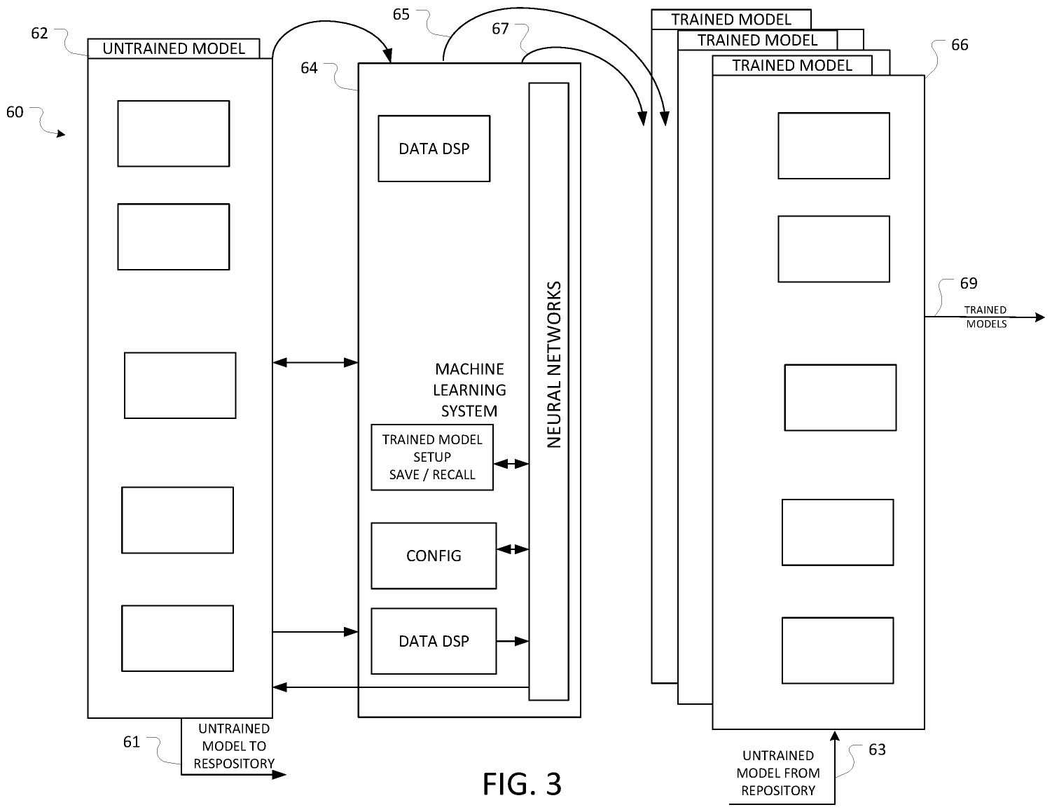

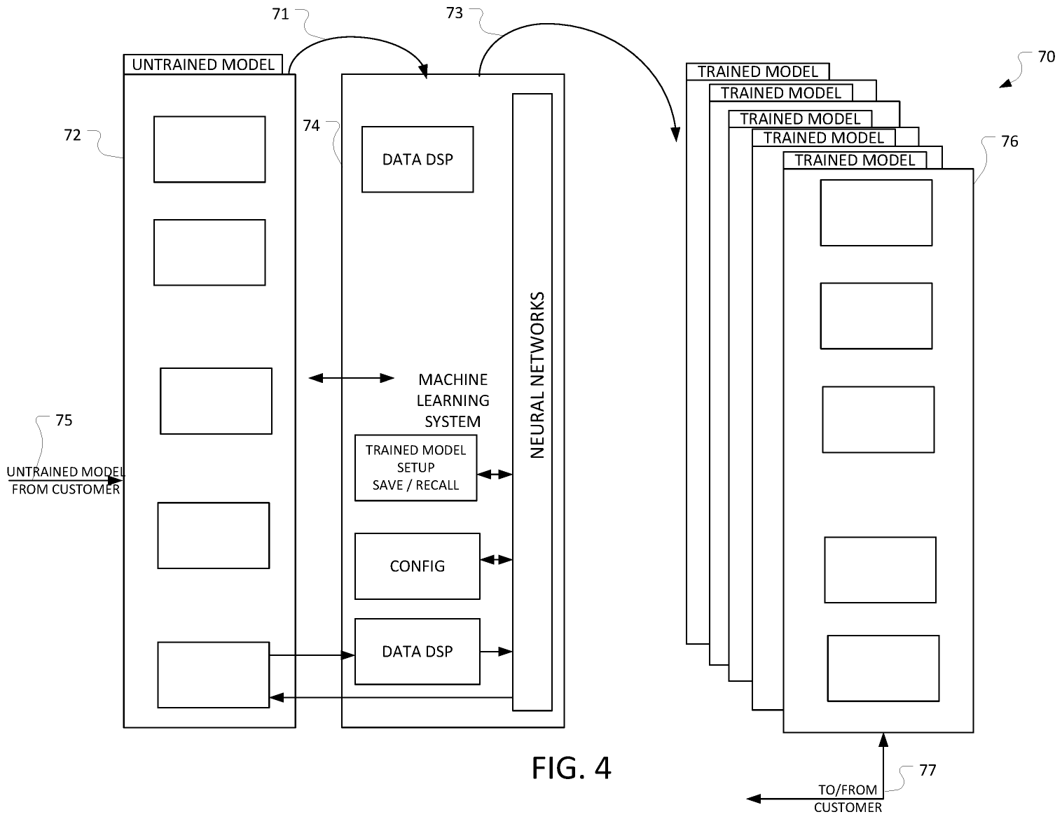

FIG. 2 shows a general block diagram of an example embodiment of a model distribution architecture, according to some embodiments of the disclosure. FIGS. 3-4 show more detailed embodiments of the elements of FIG. 2. FIG. 2 shows customer repository 60, also referred to as a local repository or as being located at a customer location. The customer owns and manages one or more computing devices, such as computers, servers, etc., that may store their trained and untrained models. The customer repository may reside on the customer's physical premises, a cloud server or account controlled by the customer, or distributed across multiple physical locations of the customer, as examples. The customer controls the customer repository, wherever or however configured.

The system has a number, M, of customers. Each customer 1 through M will have their own private local repository not accessible to other customers using the OptaML system, nor to OptaML engineers unless they are specifically given access by the customer. The access for the engineer will typically result from the customer using the system to grant access. Data from one customer is never shared with another customer. Each transmitter model is unique such that data from one transmitter model is not used when training a different transmitter model.

In the block diagram of FIG. 2, the customer local repository 60 interacts with a centralized repository, referred to here as the OptaML repository 70. The centralized repository, which may have the configurations discussed above regarding the customer repository, will have a partition for each customer. The centralized repository will have a centralized repository for each customer, for a number, Q, of customers. These repositories will remain separate from each other so no data from any one customer's repository can reach other customers' repositories.

Customer repository 60 may transfer trained models with training data to the customer partition 70 in the centralized repository. The discussion regarding FIG. 3 will cover how the customer repository has the trained models and their data. Customer repository 60 may also transfer untrained models and training data to the OptaML repository. The OptaML repository 70 may perform training of these models and will transfer the trained models back to the customer repository after training, as well as storing it in the OptaML repository for that customer. Further, upon any request from the customer, the OptaML repository can transfer other trained models and their training data to the customer from the customer's repository. The customer may request a stored model for many reasons, including validation, debugging, etc.

FIG. 2 also shows the customer's manufacturing (MFG) test stations 1 through some number, N. The customer repository 60 interacts with these stations, such as 80. Each station 80 will contain a copy of the model structure of FIG. 1. The MFG stations gather the training data used to train the models. As the MFG stations operate to test whatever DUTs need testing. During DUT testing, the MFG stations collect training data. The MFG stations will send the untrained models and their associated data back to the customer repository. Once the models are trained, discussed in more detail below, the customer repository may send the trained model, or the trained model and its associated training data to the MFG stations. Sending the model and its associated training data involves a lot more data to transfer. It does offer the advantage that OptaML may provide better debugging capabilities on individual MFG stations if problems start to occur with the MFG station. The customer may immediately visualize the training waveforms in OptaML, and then compare them to what is currently happening in the MFG station. If the customer sends just the trained models, the amount of data is of a much smaller size. This option means that for any debugging or visualization comparison of MFG line waveforms to the waveforms used for training would have to occur back at the customer repository device(s) that has the training data.

The MFG test stations comprise computers for each test station on the customer manufacturing line for testing and tuning DUTs. The computer runs the customer test automation SW for controlling the MFG line for this test station. In one embodiment, the computer runs the OptaML software, also referred to as the ML tools application, for making optimal tuning predictions for the DUT. Other embodiments of the OptaML software may provide other capabilities in the future. In this embodiment, the MFG test station receives the trained model from the customer repository. The trained model serves as the communication interface between the customer test automation software and the OptaML software The trained model contains the trained deep learning networks and the OptaML system class variable states that are needed to use the deep learning networks to make tuning predictions or measurement predictions.

The model may be an untrained model on the MFG Test station. If the MFG test station implements the live training data collection while the MFG line is in operation, then they will collect training data into the untrained model storage structure until they have collected enough data. At various points in time, untrained models may be transferred from the MFG Test station back to the customer repository.

If the customer test automation software has implemented live training data collection, then an untrained model may be used on the MFG Test station while the data is being collected. Once the station has collected enough data, the data be transferred from the MFG test station to the customer repository where it may then be used to perform training to obtain a trained model. It may also be transferred from the customer repository to the OptaML repository and trained at the OptaML location. The model undergoes training discussed in more detail below, either remotely by an engineer, locally at the customer's location, or at the centralized repository. Training locally may occur based upon a password or other access grant from the OptaML system to the customer.

FIG. 3 shows a more detailed view of an embodiment of the customer repository. The storage structures 62 and 66 represent specific implementations of the data store 30 from FIG. 1. The ML tools application 64 represents a specific implementation of the ML tools application—OptaML—50 from FIG. 1.

The customer repository may contain untrained models where the customer has created the model storage structure and collected training data to put into it. The untrained models may become trained models in one of many ways. In one embodiment, the OptaML engineer may perform the training operation in the customer local repository and create a trained model that is now stored in the local repository shown at arrow 65. The local repository then transfers a copy of the trained model to the remote, centralized, OptaML repository as indicated by the arrow 69. The means for transferring the model from local repository 60 to remote repository 70 may also happen in any means, across a network, copied via some sort of physical media. In some embodiments, it is also possible that the OptaML software application may implement a direct communication and managed data link between versions of it running on the local customer repository location and version of it running on the remote OptaML location. However, some customers cannot have a direct communication link from a customer MFG test station back to an OptaML remote repository.

In an alternative embodiment, the customer may send the untrained model over to the OptaML remote repository where the OptaML engineer may train the model. The arrow 61 at the bottom of the untrained model store 62 represents this embodiment. In an alternative embodiment, the customer may, if allowed by their particular OptaML license, perform the training, and save it in the customer repository as shown by arrow 67. They may also send a copy to OptaML to be stored in the OptaML repository along the same path using arrow 69, as may be a part of their license agreement. OptaML repository will then transfer the trained model back to the customer repository for trained models 66 as shown by the arrow 63 at the bottom of the trained model repository.

One consideration involves how to name the models when they are created for training. A version number for a model may be incorporated into the model's name. During training, many models with different versions may result from the process of tuning the tensor builder and hyperparameters for the training of the neural network. The system can then track the performance of the models to identify the best model. This would help in the future if new training must be performed with new training data added. The customer may then delete all models that do not perform well and only keep the relevant ones. Version control may include Version number and/or other tagging, history, and other metadata such as performance statistics.

FIG. 4 shows a more detailed embodiment of the centralized, remote, OptaML, repository 70. The remote repository described below should enable the OptaML engineer to at any time load one of the customers model versions remotely. The OptaML engineer can then help customers with any maintenance or debugging issues addressable remotely without the user test automation SW part of the system. For example, this could include data analysis and model validation checks.

As mentioned above, the centralized repository 70 resides at the provider, Tektronix. Referring to FIG. 2, the centralized repository has Q repositories, or partitions, in the centralized repository, such as one for each different OptaML application that is created over time. Examples may include different models for optical transceiver tuning, applications for other use cases, tests, measurements, calibrations, tuning applications, etc. This repository may contain the trained models for all customers that have paid to perform training for their models. The customer partition may in turn have partitions as sub-repositories dedicated to different models, different versions of a same model and different components.

Referring to FIG. 4, OptaML will manage model data in several ways as described below. This repository may contain trained or untrained models. The trained model portion 76 of the OptaML repository 70 may receive a trained model from a customer repository, as shown as arrow 77, if the training was done in the local customer repository by either an OptaML engineer or a customer. The OptaML remote repository may receive untrained models, shown by arrow 75, to the untrained model portion 72. These come from the customer repository after the customer has collected enough training data for training to proceed.

An OptaML engineer may use the OptaML, or Tools application 74, which represents the specific implementation of the tool application 50 from FIG. 1, to perform the training in this OptaML repository when an untrained model is received from a customer repository. FIG. 4 represents the training process with arrow 71, which is then stored to the trained model portion 76 shown by arrow 73. After training, the system should transfer a copy of the trained model back to the customer repository, shown by arrow 77. As mentioned above, the system will never share trained models with other customers, unless agreed to by mutual customers. It only sends the trained model back to the customer who provided the untrained model to use for training.

Storing the models in the centralized repository has several advantages. They allow for service interactions with the various customers. This may include debugging problems, helping customers visualize their data, as examples.

In summary, the embodiments describe a machine learning model distribution and management architecture to handle the interactions between a customer's local model repository and a remote OptaML model repository. Original training data is collected by the users test automation SW and deposited into an untrained model structure in the customer repository. The untrained model may be trained in the customers local repository, or it may be copied over to the OptaML repository and trained there. When a model is trained, a copy of it shall be saved in both the customer repository and the OptaML repository. OptaML may use the model in their repository for service interactions with the customer and they may use it for other research purposes if allowed by the customer. The customer may then distribute the trained models from their local repository out to their individual MFG test stations. Each customer has their own local repositories and data from one customer is never shared with other customers. That transfer to the MFG test stations may include the training data in the model. That transfer may exclude the training data from the model depending on how they wish to operate the system. Therefore, this disclosure describes a complete architecture for the management of trained and untrained models between customer repositories and OptaML repository.

Aspects of the disclosure may operate on a particularly created hardware, on firmware, digital signal processors, or on a specially programmed general purpose computer including a processor operating according to programmed instructions. The terms controller or processor as used herein are intended to include microprocessors, microcomputers, Application Specific Integrated Circuits (ASICs), and dedicated hardware controllers. One or more aspects of the disclosure may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a non-transitory computer readable medium such as a hard disk, optical disk, removable storage media, solid state memory, Random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, FPGA, and the like. Particular data structures may be used to more effectively implement one or more aspects of the disclosure, and such data structures are contemplated within the scope of computer executable instructions and computer-usable data described herein.

The disclosed aspects may be implemented, in some cases, in hardware, firmware, software, or any combination thereof. The disclosed aspects may also be implemented as instructions carried by or stored on one or more or non-transitory computer-readable media, which may be read and executed by one or more processors. Such instructions may be referred to as a computer program product. Computer-readable media, as discussed herein, means any media that can be accessed by a computing device. By way of example, and not limitation, computer-readable media may comprise computer storage media and communication media.

Computer storage media means any medium that can be used to store computer-readable information. By way of example, and not limitation, computer storage media may include RAM, ROM, Electrically Erasable Programmable Read-Only Memory (EEPROM), flash memory or other memory technology, Compact Disc Read Only Memory (CD-ROM), Digital Video Disc (DVD), or other optical disk storage, magnetic cassettes, magnetic tape, magnetic disk storage or other magnetic storage devices, and any other volatile or nonvolatile, removable or non-removable media implemented in any technology. Computer storage media excludes signals per se and transitory forms of signal transmission.

Communication media means any media that can be used for the communication of computer-readable information. By way of example, and not limitation, communication media may include coaxial cables, fiber-optic cables, air, or any other media suitable for the communication of electrical, optical, Radio Frequency (RF), infrared, acoustic or other types of signals.

### Examples

Illustrative examples of the disclosed technologies are provided below. An embodiment of the technologies may include one or more, and any combination of, the examples described below.

Example 1 is a machine learning management system, comprising: a repository having one or more partitions, the one or more partitions being separate from others of the one or more partitions; a communications interface; and one or more processors configured to execute code to cause the one or more processors to: receive a selected model and associated training data for the selected model through the communications interface from a customer; store the selected model and the associated training data in a partition dedicated to the customer; and manage the one or more partitions to ensure that the customer can only access the partition dedicated to the customer.

Example 2 is the machine learning management system of Example 1, wherein the one or more processors are further configured to: train the selected model using the associated training data prior to storing the selected model and the associated training data; and send the selected model and the associated training data to the customer after the training.

Example 3 is the machine learning management system of either of Examples 1 and 2, wherein the selected model is a trained model.

Example 4 is the machine learning management system of any of Examples 1 through 3 1, wherein the one or more processors are further configured to: receive a request for a trained model stored in the partition dedicated to the customer; access the partition dedicated to the customer to retrieve the trained model and the training data associated with the trained model; and send the trained model and the training data associated with the trained model to the customer.

Example 5 is the machine learning management system of any of Examples 1 through 4 1, wherein the one or more processors are further configured to execute code to allow the one or more processors to access one or more computing devices located at a customer location.

Example 6 is the machine learning management system of Example 5, wherein the code that causes the one or more processors to access the one or more computing devices comprises code to allow the one or more processors to train untrained models on the one or more computing devices remotely.

Example 7 is the machine learning management system of Example 5, wherein the code that causes the one or more processors to access the one or more computing devices causes the one or more processors to debug trained models on the one or more computing devices remotely.

Example 8 is the machine learning management system of any of Examples 1 through 7, wherein the one or more processors are further configured to execute code that causes the one or more processors to allow the customer to train models locally at a customer location.

Example 9 is the machine learning management system of any of Examples 1 through 6, wherein the partition in the repository dedicated to the customer contains one or more partitions, each of the one or more partitions comprising sub-repositories dedicated to one or more of different models, different versions of a same model, and different components.

Example 10 is a method, comprising: receiving a selected model and associated training data for the selected model through a communications interface from a customer; storing the selected model and the associated training data in a partition dedicated to the customer in a repository; and managing the one or more partitions to ensure that the customer can only access the partition dedicated to the customer.

Example 11 is the method of Example 10, further comprising: training the selected model using the associated training data prior to storing the selected model and the associated training data; and sending the selected model and the associated training data to the customer after the training.

Example 12 is the method of either of Examples 10 or 11, wherein receiving the selected model and the associated training data comprises receiving a trained model and associated training data from the customer.

Example 13 is the method of any of Examples 10 through 12, further comprising: receiving a request for a trained model stored in the partition dedicated to the customer; accessing the partition dedicated to the customer to retrieve the trained model and associated training data associated with the trained model; and sending the trained model and the associated training data associated with the trained model to the customer.

Example 14 is the method of Example 13, further comprising accessing one or more computing devices located at a customer location.

Example 15 is the method of Example 14 wherein accessing the one more computing devices located at the customer location comprises accessing the one or more computing devices to use the one or more computing devices to train one or more untrained models on the one or more computing devices remotely.

Example 16 is the method of Example 14, wherein accessing the one more computing devices located at the customer location comprises accessing the one or more computing devices to use the one or more computing devices to debug trained models on the one or more computing devices remotely.

Example 17 is the method of any of Examples 10 through 16, further comprising allowing the customer to train models locally at a customer location.

The previously described versions of the disclosed subject matter have many advantages that were either described or would be apparent to a person of ordinary skill. Even so, these advantages or features are not required in all versions of the disclosed apparatus, systems, or methods.

Additionally, this written description makes reference to particular features. It is to be understood that the disclosure in this specification includes all possible combinations of those particular features. Where a particular feature is disclosed in the context of a particular aspect or example, that feature can also be used, to the extent possible, in the context of other aspects and examples.

Also, when reference is made in this application to a method having two or more defined steps or operations, the defined steps or operations can be carried out in any order or simultaneously, unless the context excludes those possibilities.

Although specific examples of the invention have been illustrated and described for purposes of illustration, it will be understood that various modifications may be made without departing from the spirit and scope of the invention. Accordingly, the invention should not be limited except as by the appended claims.

1. A machine learning management system, comprising:
a repository having one or more partitions, the one or more partitions being separate from others of the one or more partitions;
a communications interface; and
one or more processors configured to execute code to cause the one or more processors to:
receive a selected model and associated training data for the selected model through the communications interface from a customer;
store the selected model and the associated training data in a partition dedicated to the customer; and
manage the one or more partitions to ensure that the customer can only access the partition dedicated to the customer.

2. The machine learning management system as claimed in claim 1, wherein the one or more processors are further configured to:
train the selected model using the associated training data prior to storing the selected model and the associated training data; and
send the selected model and the associated training data to the customer after the training.

3. The machine learning management system as claimed in claim 1, wherein the selected model is a trained model.

4. The machine learning management system as claimed in claim 1, wherein the one or more processors are further configured to:
receive a request for a trained model stored in the partition dedicated to the customer;
access the partition dedicated to the customer to retrieve the trained model and the training data associated with the trained model; and
send the trained model and the training data associated with the trained model to the customer.

5. The machine learning management system as claimed in claim 1, wherein the one or more processors are further configured to execute code to allow the one or more processors to access one or more computing devices located at a customer location.

6. The machine learning management system as claimed in claim 5, wherein the code that causes the one or more processors to access the one or more computing devices comprises code to allow the one or more processors to train untrained models on the one or more computing devices remotely.

7. The machine learning management system as claimed in claim 5, wherein the code that causes the one or more processors to access the one or more computing devices causes the one or more processors to debug trained models on the one or more computing devices remotely.

8. The machine learning management system as claimed in claim 1, wherein the one or more processors are further configured to execute code that causes the one or more processors to allow the customer to train models locally at a customer location.

9. The machine learning management system as claimed in claim 1, wherein the partition in the repository dedicated to the customer contains one or more partitions, each of the one or more partitions comprising sub-repositories dedicated to one or more of different models, different versions of a same model, and different components.

10. A method, comprising:
receiving a selected model and associated training data for the selected model through a communications interface from a customer;
storing the selected model and the associated training data in a partition dedicated to the customer in a repository; and
managing the one or more partitions to ensure that the customer can only access the partition dedicated to the customer.

11. The method as claimed in claim 10, further comprising:
training the selected model using the associated training data prior to storing the selected model and the associated training data; and
sending the selected model and the associated training data to the customer after the training.

12. The method as claimed in claim 10, wherein receiving the selected model and the associated training data comprises receiving a trained model and associated training data from the customer.

13. The method as claimed in claim 10, further comprising:
receiving a request for a trained model stored in the partition dedicated to the customer;
accessing the partition dedicated to the customer to retrieve the trained model and associated training data associated with the trained model; and
sending the trained model and the associated training data associated with the trained model to the customer.

14. The method as claimed in claim 13, further comprising accessing one or more computing devices located at a customer location.

15. The method as claimed in claim 14 wherein accessing the one more computing devices located at the customer location comprises accessing the one or more computing devices to use the one or more computing devices to train one or more untrained models on the one or more computing devices remotely.

16. The method as claimed in claim 14, wherein accessing the one more computing devices located at the customer location comprises accessing the one or more computing devices to use the one or more computing devices to debug trained models on the one or more computing devices remotely.

17. The method claimed in claim 10, further comprising allowing the customer to train models locally at a customer location.
